(19) United States
(12) Patent Application Publication
(10) Pub. No.: US 2020/0039411 A1
(43) Pub. Date: Feb. 6, 2020

(54) System and Method for Controlling Temperature of a Beverage using a Temperature-Controlled Cup Holder

(71) Applicant: Susan Paschal, Humble, TX (US)

(72) Inventor: Susan Paschal, Humble, TX (US)

(21) Appl. No.: 16/055,026

(22) Filed: Aug. 4, 2018

(51) Int. Cl. B60N 3/10; A47G 23/02; F25B 21/04; F25D 31/00

(52) U.S. Cl. CPC B60N 3/104; A47G 23/0216; F25B 2321/0212; F25D 31/006; A47G 2023/0283; F25B 21/04

(57) ABSTRACT

A temperature-controlled cup holder is disclosed. The temperature-controlled cup holder can comprise a conducting inner layer, a conducting outer layer, a middle layer, a control system, and a control device. The conducting inner layer can be capable of mounting a cup. The middle layer can be in between the conducting inner layer and the conducting outer layer. The middle layer can comprise a first side and a second side. The middle layer can further comprise a first thermoelectric network comprising one or more first thermoelectric coolers. Each of the one or more first thermoelectric coolers can comprise a hot side. The hot sides can each be oriented to be facing the first side. The control system can control the activation of the first thermoelectric network. The control device can be connected to the control system operable to give information related to a preferred temperature setting.

### BACKGROUND

This disclosure relates to a system and method for controlling temperature of a beverage using a temperature-controlled cup-holder. Automobile cup holders are used to keep a driver's beverage secure, thereby preventing spillage on the automobile's interior. Though automobile cup holders provide an effective way of securing a cup, automobile a cup holder does not substantially prevent a beverage from staying at its ideal temperature. For example, ice can melt into a drink, watering it down. Similarly, hot coffee can become luke-warm. As such it would be useful to have an improved system and method for controlling temperature of a beverage using a temperature-controlled cup-holder.

### SUMMARY

A system and method for controlling temperature of a beverage using a temperature-controlled cup holder is described herein. The cup holder can comprise a conducting inner layer, a conducting outer layer, a middle layer, a control system, and a control device. The conducting inner layer can be capable of mounting a cup. The middle layer can be in between the conducting inner layer and the conducting outer layer. The middle layer can comprise a first side and a second side. The middle layer can further comprise a first thermoelectric network comprising one or more first thermoelectric coolers. Each of the one or more first thermoelectric coolers can comprise a hot side. The hot sides can each be oriented to be facing the first side. The control system can control the activation of the first thermoelectric network. The control device can be connected to the control system operable to give information related to a preferred temperature setting.

A method for controlling temperature of a cup holder comprising the step placing a cup within the cup holder. The cup holder can comprise a conducting inner layer, a conducting outer layer, a middle layer, a control system and a control device. The conducting inner layer can be capable of mounting a cup. The middle layer can be in between the conducting inner layer and the conducting outer layer. The middle layer can comprise a first side and a second side. The middle layer can further comprise a first thermoelectric network comprising one or more first thermoelectric coolers. Each of the one or more first thermoelectric coolers can comprise a hot side. The hot sides can each be oriented to be facing the first side. The control system can control the activation of the first thermoelectric network. The control device can be connected to the control system operable to give information related to a preferred temperature setting. The steps can further comprise receiving information from the control device and heating or cooling the cup based on the information from the control device.

### BRIEF DESCRIPTION OF THE DRAWINGS

FIG. 1 illustrates a cup mounted within a built-in automobile cup holder.

FIG. 2A illustrates a top view embodiment of a cup holder.

FIG. 2B illustrates a sectional view embodiment of a cup holder.

FIG. 2C illustrates an embodiment of middle layer comprising a plurality of thermoelectric coolers.

FIG. 2D illustrates an embodiment of a control system.

FIG. 3 illustrates an embodiment of a cup holder that uses a temperature sensor.

FIG. 4A illustrates a cup comprising a machine-readable medium being placed in a cup holder.

FIG. 4B illustrates electronic data on a machine-readable medium.

FIG. 5 illustrates an embodiment of a cup holder comprising a two-pole switch.

FIG. 6 illustrates an embodiment of a cup holder comprising a four-pole switch.

### DETAILED DESCRIPTION

Described herein is a system and method for controlling temperature of a beverage using a temperature-controlled a cup-holder. The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

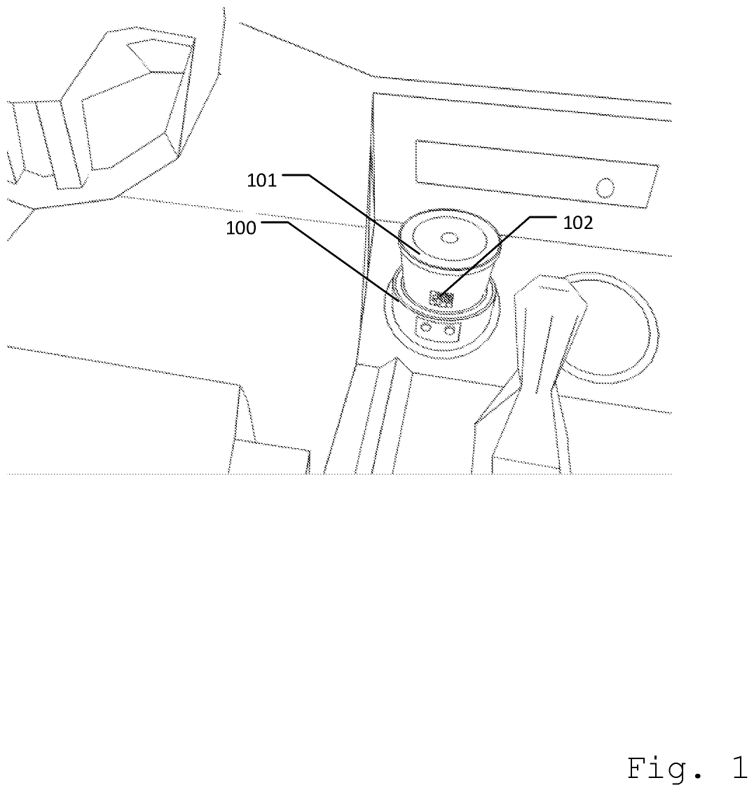

FIG. 1 illustrates a cup 101 within a cup holder 100. Cup holder 100 can be a built in cup holder on an automobile that can hold cup 101 or any other drinking vessel. In one embodiment, cup holder 100 can be a single cup holder capable of holding a single cup. In other embodiments, cup holder 100 can be a multiple cup holder. In such embodiment, cup holder 100 can hold two or more cups. In such embodiments, cup holder 100 can be used to substantially maintain the temperature of beverages within cup 101. In one embodiment, cup 101 can comprise a machine-readable medium 102. Machine-readable medium 102 can be a medium capable of storing data in a format that can be readable by a mechanical device such as barcode readers or scanners. Examples of machine-readable medium 102 can include but are not limited to radio frequency identification chips (RFIDs) and barcodes. Some examples of barcodes are Universal Product Codes (UPC) and Quick Response Codes (QRC).

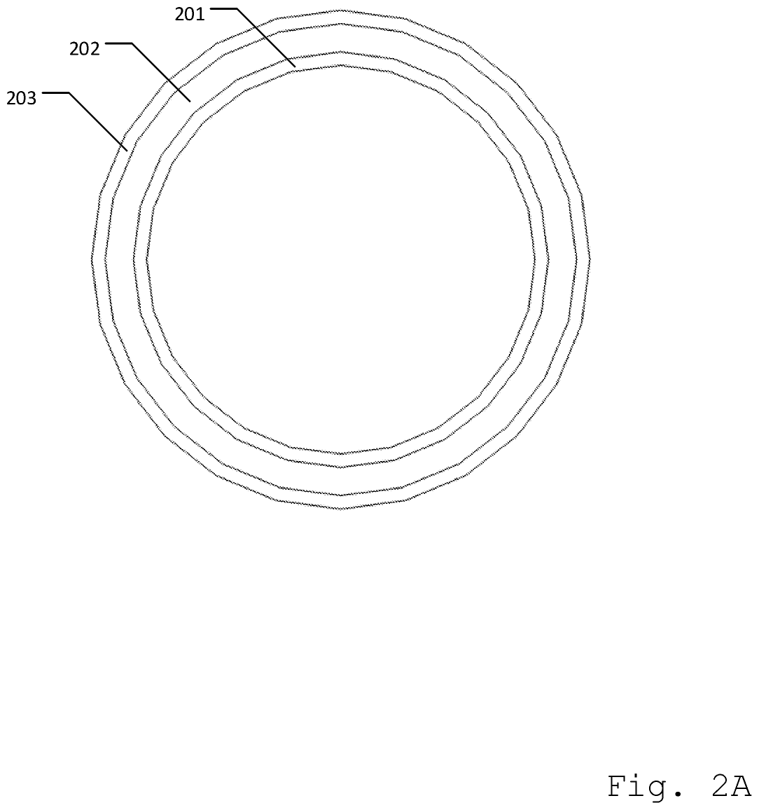

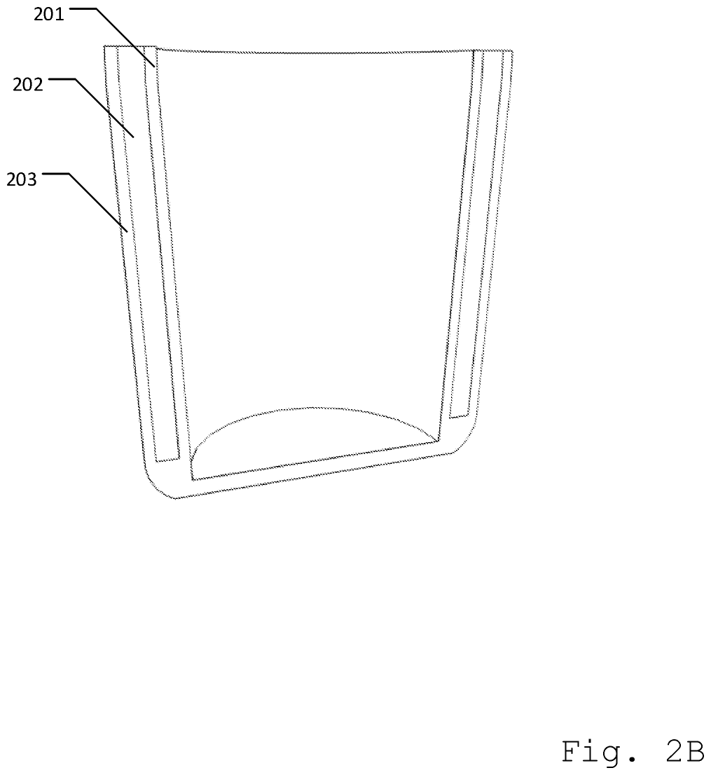

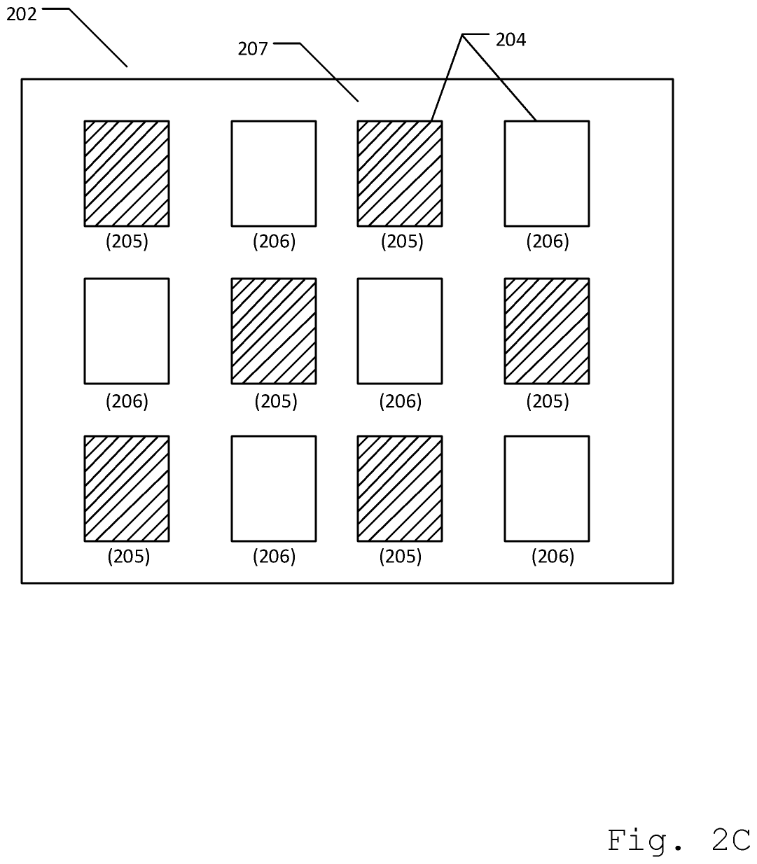

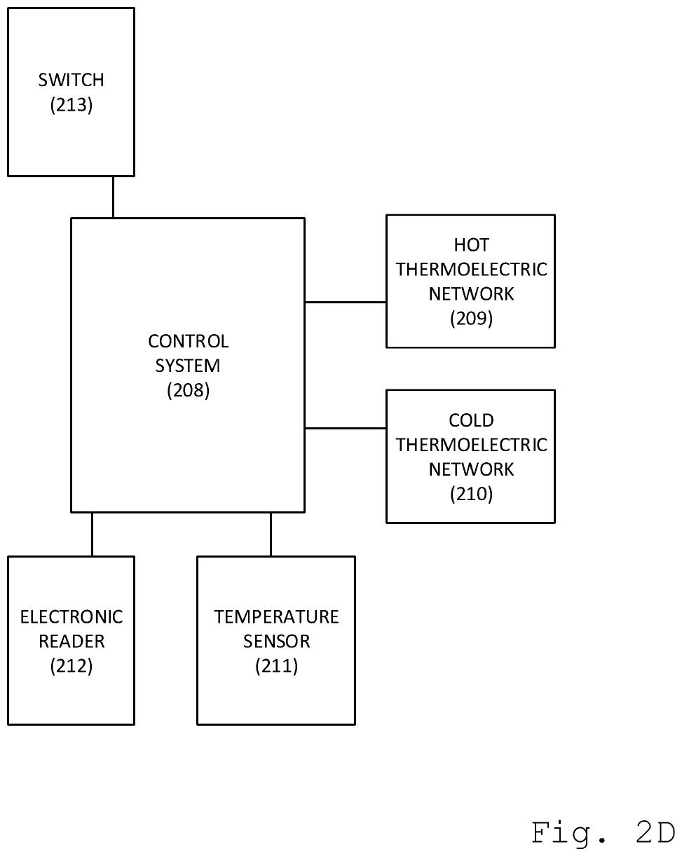

FIG. 2A illustrates a top view embodiment of cup holder 100. In one embodiment, cup holder 100 can comprise a conducting inner layer 201, a middle layer 202, and a conducting outer layer 203. Conducting outer layer 203 can be the exterior surface of cup holder 100 while conducting inner layer 201 can be the interior surface of cup holder 100. As such, conducting inner layer 201 can be the portion of cup holder 100 that can come in contact with cup 101. Middle layer 202 can be the middle section of cup holder 100 placed in between conducting inner layer 201 and conducting outer layer 203.

FIG. 2B illustrates a sectional view embodiment of cup holder 100. In one embodiment, middle layer 202 can comprise one or more thermoelectric coolers 204. Each thermoelectric 204 cooler is a solid-state active heat pump, which transfers heat from one side of the device to the other by using the Peltier effect to create a heat flux between the junctions of two different types of materials. The effect is such that each thermoelectric has a side above ambient temperature, and a side below ambient temperature, described further below as a hot side and a cold side. Thus, middle layer 202 can comprise a first side and a second side such that when an electric current flows through cup holder 100, heat can flow from the first side to the second side or vice versa, so that one side gets cooler and the other gets hotter. As such, middle layer 202 can be used to manage the temperature of cup holder 100, as will be described further below. In these embodiments, conducting inner layer 201 can transfer the temperature into or out of cup 101 while conducting outer layer 203 can dissipate the temperature accordingly.

FIG. 2C illustrates an embodiment of middle layer 202 comprising a plurality of thermoelectric coolers 204. Each thermoelectric cooler 204 can comprise a hot side 205 and a cold side 206. In one embodiment, a first subset of thermoelectric coolers 204 can be oriented within middle layer 202 such that each hot side 205 of the first subset of thermoelectric coolers 204 faces conducting inner layer 201. Further, in such embodiment, a second subset of thermoelectric coolers 204 can be oriented within middle layer 202 such that each cold side 206 of the second subset of thermoelectric coolers 204 faces conducting inner layer 201. In one embodiment, hot sides 205 of the first subset can be arranged in a checkerboard pattern within middle layer 202 with cold sides 206 of the second subset. To heat a beverage, one or more of the first subset of thermoelectric coolers 204 can be activated. To cool a beverage, one or more of the second subset of thermoelectric coolers 204 can be activated. Evenly distributing thermos electric coolers in a checkerboard or other pattern can help the beverage is evenly heated or cooled. Middle layer 202 can further comprise an insulator 207 capable of supporting thermoelectric coolers 204 within middle layer 202 and resisting heat transfer between conducting inner layer 201 and conducting outer layer 203.

FIG. 2D illustrates an embodiment of control system 208. In one embodiment, middle layer 202 can further comprise control system 208 that controls thermoelectric coolers 204. In one embodiment, the first set of thermoelectric coolers 204 can be wired into a hot thermoelectric network 209 and the second set of thermoelectric coolers 204 can be wired into a cold thermoelectric network 210. Thermoelectric coolers 204 of hot thermoelectric network 209 can be wired in parallel in one embodiment. Similarly, thermoelectric coolers 204 of cold thermoelectric network 210 can also be wired together in parallel in one embodiment. For purposes of this disclosure a “network” of thermoelectric coolers 204 can comprise one or more thermoelectric coolers 204. Control system 208 can activate either hot thermoelectric network 209 or cold thermoelectric network 210. For example in an embodiment wherein the first side of middle layer 202 can be facing conducting inner layer 201, to heat a beverage, control system 208 can activate hot thermoelectric network 209, causing heat to transfer from cold sides 206 to hot sides 205, and into conducting inner layer 201 while heat from the environment can warm conducting outer layer 203. Similarly, to cool a beverage, control system 208 can activate cold thermoelectric network 210 causing heat to transfer from cold sides 206, pulling heat from conducting inner layer 201 and beverage, to hot sides 205, and into conducting outer layer 203, allowing heat to escape into the environment. In another example embodiment wherein the first side of middle layer 202 can be facing conducting outer layer 203, to heat a beverage, control system 208 can activate cold thermoelectric network 210 causing heat to transfer from cold sides 206 to hot sides 205 and into conducting inner layer 201 pulling heat into conducting inner layer 201 and beverage. Likewise, to cool a beverage, control system 208 can activate hot thermoelectric network 209 causing heat to transfer from cold sides 206 to hot sides 205 and dissipating heat to conducting outer layer 203.

Further, control system 208 can be connected to a control device that determines a preferred temperature setting to be applied on cup holder 100. In one embodiment, control device can be a temperature sensor 211. In such embodiment, temperature sensor 211 can detect when a hot beverage is put in cup holder 100. Similarly, temperature sensor 211 can detect when a cold beverage is put in cup holder 100. Control system 208 can be programmed to heat warm beverages and chill cold beverages. In another embodiment, temperature sensor 211 can sense if cup holder 100 gets too hot or too cold and shut off thermoelectric coolers 204.

In another embodiment, control device can be an electronic reader 212. In such embodiment, control system 208 can direct thermoelectric coolers 204 to heat or cool according to information stored within machine-readable medium 102 on cup 101.

Further in another embodiment, control device can be a switch 213 connected to control system 208. In such embodiment, the selected mode on switch 213 gets relayed to control system 208. As such, control system 208 manages which mode gets activated on cup holder 100. In one embodiment, switch 213 can be a two-pole switch that can allow a user to set cup holder's temperature into “Hot” or “Cold”. In another embodiment, switch 213 can be a four-pole switch that can allow a user to set cup holder's temperature into “Hot”, “Cold”, “Off”, and “Auto”. In Auto mode, a second control device such as temperature sensor 211 can be implemented and used to determine when cupholder is put in hot or cold mode, as described above.

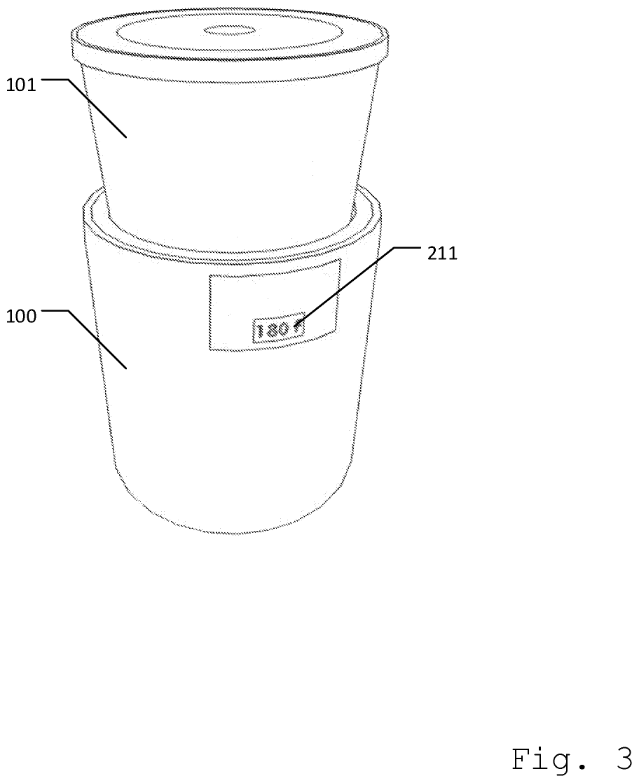

FIG. 3 illustrates an embodiment of cup holder 100 that uses temperature sensor 211. In this embodiment, cup 101 can be any disposable cup. When cup 101 is placed into cup holder 100, temperature sensor 211 reads the temperature of cup 101. The measured temperature recorded through temperature sensor 211 can be transmitted to control system 208. As such, control system 208 can activate the thermoelectric layer according to the same temperature detected by temperature sensor 211. Thus, when temperature sensor 211 detects that cup 101 is hot, control system 208 can activate hot thermoelectric network 209, and when temperature sensor 211 reads that cup 101 is cold, control system 208 can activate cold thermoelectric network 210. In other embodiments, the exact temperature detected by temperature sensor 211 can be applied to cup holder 100. In such embodiment, control system 208 can regulate the activation of hot thermoelectric network 209 and cold thermoelectric network 210 to keep the temperature the same with the measured temperature made by temperature sensor 211.

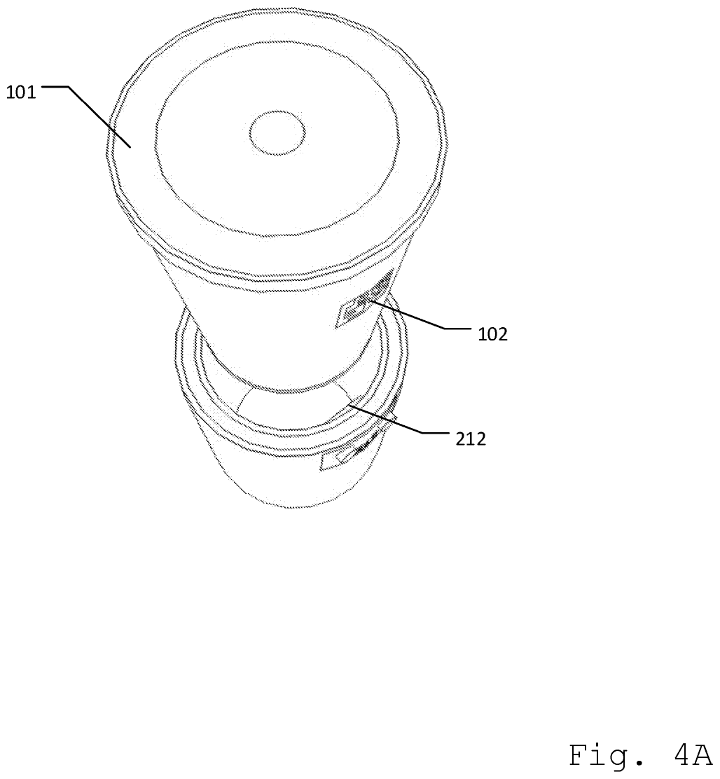

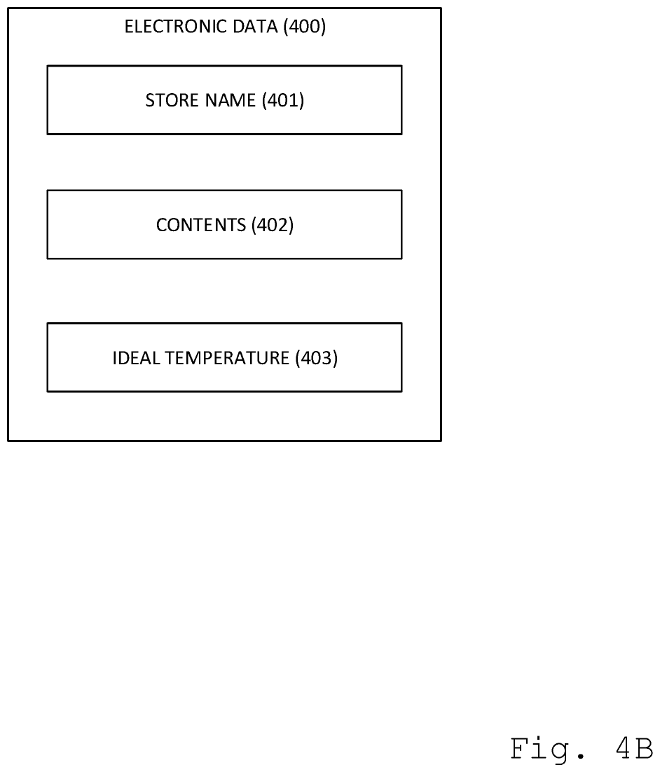

FIG. 4A illustrates a cup comprising machine-readable medium 102 being placed on cup holder 100. In this embodiment cup 101 can comprise machine-readable medium 102 and electronic reader 212 can be used to read and decode an electronic data 400 stored within machine-readable medium 102.

FIG. 4B illustrates electronic data 400 on machine-readable medium 102. As an example embodiment, electronic data 400 can include but is not limited to beverage information such as store name 401, contents 402, ideal temperature 403, etc. Store name 401 can be the name of the restaurant, store, or café wherein cup 101 can be bought. Content 402 can be the kind of beverage contained in cup 101, such as coffee, tea, juice, soda, etc. Ideal temperature 403 can be “hot” or “cold” designation or an actual preferred temperature for the beverage contained in cup 101. In this embodiment, control system 208 can use the information within machine-readable medium 102 to determine whether cup holder 100 should heat or cool the beverage, and in some embodiments, to what temperature. As such, when electronic data 400 on cup 101 contains contents 402 or ideal temperature 403, control system 208 can activate the thermoelectric network that matches the information found on machine-readable medium 102. For example, when content 402 on machine-readable medium 102 is set to “ice tea” control system 208 can activate cold thermoelectric network 210 to keep cup holder 100 cold. In another example, when ideal temperature 403 set on machine-readable medium 102 is 140-degree Fahrenheit then control system 208 can activate hot thermoelectric network 209 to keep cup holder 100 warm.

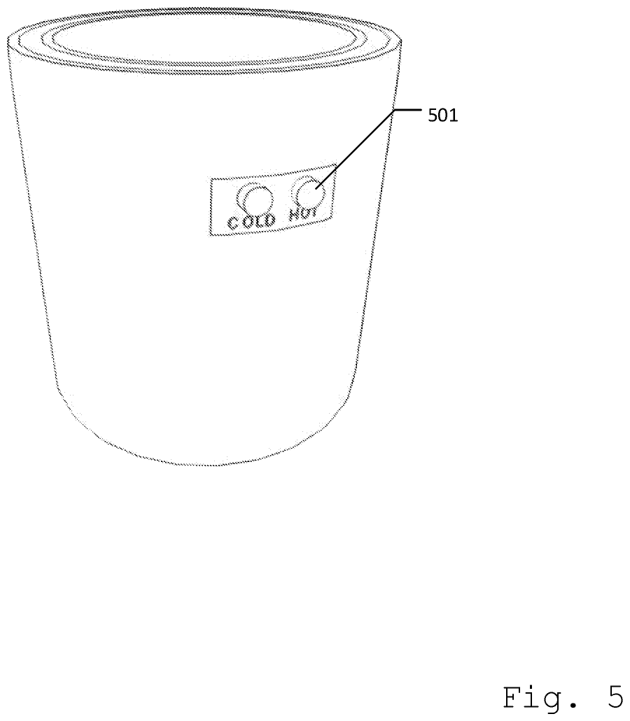

FIG. 5 illustrates an embodiment of cup holder 100 comprising a two-pole switch 501. Switch 213 can be a device, such as a button, lever, control, etc. that can allow the user to choose which temperature can be applied on cup holder 100. As such, the selected mode on switch 213 gets relayed to control system 208. Then, control system 208 manages which mode gets activated on cup holder 100. In one embodiment, switch 213 can be placed at the outer surface of cup holder 100 to allow accessibility. In this embodiment, switch 213 can be two-pole switch 501 that can allow a user to set cup holder's temperature into “Hot” or “Cold”. In such embodiment, when the user sets two-pole switch 501 to “hot” control system 208 can activate hot thermoelectric network 209 on cup holder 100, and vice versa. In such embodiment, a sensor such as a switch or other device known in the art can be mounted within cup holder to let system turn system off when cup 101 is not in cup holder 100.

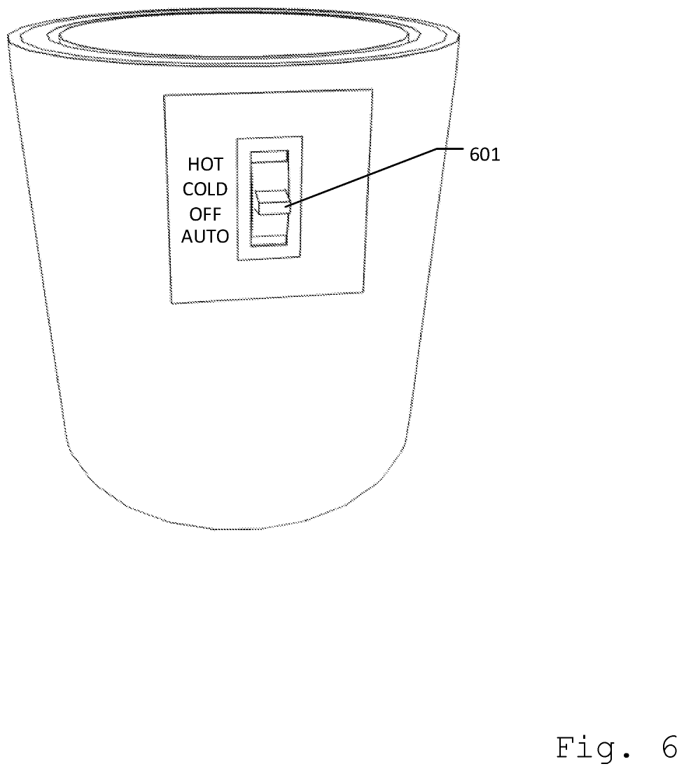

FIG. 6 illustrates an embodiment of cup holder 100 comprising a four-pole switch 601. In this embodiment, switch 213 can be a four-pole switch that can allow a user to set cup holder 100 to “Hot”, “Cold”, “Off”, and “Auto”. In an embodiment wherein four-pole switch 601 can be set to “Hot”, control system 208 can activate hot thermoelectric network 209 to keep cup holder 100 in hot temperature. When four-pole switch 601 can be set to “Cold”, control system 208 can activate cold thermoelectric network 210 to keep cup holder 100 in cold temperature. In another embodiment wherein four-pole switch 601 can be set to “Auto”, temperature sensor 211 and electronic reader 212 can be on a standby mode. As such, either temperature sensor 211 or electronic reader 212 can be activated when cup 101 is placed within cup holder 100. In a scenario wherein ordinary disposable cup 101 is placed within cup holder 100, temperature sensor 211 can be used to read the temperature of cup 101. Then, control system 208 can activate the correct thermoelectric cooler(s) 204. In another scenario wherein cup 101 with machine-readable medium 102 can be placed within cup holder 100, electronic data 400 can be decoded through electronic reader 212 and transmitted to control system 208. In turn, control system 208 can activate the appropriate thermoelectric cooler(s) 204 in cup holder 100 according to the information gathered from electronic data 400 of machine-readable medium 102. Further in an embodiment wherein four-pole switch 601 can be set to “Off”, no electric current can be transmitted to one or more thermoelectric coolers 204.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A system for controlling temperature of a cup holder comprising
a conducting inner layer capable of mounting a cup;
a conducting outer layer; and
a middle layer in between said conducting inner layer and said conducting outer layer, said middle layer comprising a first side and a second side, said middle layer further comprising a first thermoelectric network comprising one or more first thermoelectric coolers, each of said one or more first thermoelectric coolers comprising a hot side, said hot sides each oriented to be facing said first side;
a control system that controls the activation of said first thermoelectric network; and
a control device connected to said control system operable to give information related to a preferred temperature setting.

2. The system of claim 1 wherein said middle layer further comprises a second thermoelectric network comprising one or more second thermoelectric coolers, each of said one or more second thermoelectric coolers comprising a cold side, said cold sides each oriented to be facing said first side, further wherein said control system further controls the activation of said second thermoelectric network.

3. The system of claim 2 wherein said first side faces said inner layer.

4. The system of claim 3 wherein when said temperature is set to hot, said control system activates said first thermoelectric network.

5. The system of claim 1 wherein when said temperature is set to cold, said control system activates said second thermoelectric network.

6. The system of claim 2 wherein said first side faces said outer layer.

7. The system of claim 6 wherein when said temperature is set to hot, said control system activates said second thermoelectric network.

8. The system of claim 6 wherein when said temperature is set to cold, said control system activates said first thermoelectric network.

9. The system of claim 1 wherein said control device comprises a switch that allows a user to manually activate the thermoelectric network.

10. The system of claim 7 wherein said switch comprises a two-pole switch, said two-pole switch allows said control system be set to either hot or cold.

11. The system of claim 10 wherein said switch comprises a four-pole switch, said four-pole switch allows said control system be set to either hot, cold, off, or auto.

12. The system of claim 1 wherein said control device comprises a temperature sensor.

13. The system of claim 1 wherein said control device comprises an electronic reader, said electronic reader capable of reading a machine-readable code on a cup and transmitting said information to said control system.

14. The system of claim 1 wherein said middle layer comprises an insulator, said insulator that supports said plurality of hot sides and said plurality of cold sides.

15. A method for controlling temperature of a cup holder comprising the steps.
placing a cup within said cup holder, said cup holder comprising
a conducting inner layer capable of mounting a cup;
a conducting outer layer; and
a middle layer in between said conducting inner layer and said conducting outer layer, said middle layer comprising a first side and a second side, said middle layer further comprising a first thermoelectric network comprising one or more first thermoelectric coolers, each of said one or more first thermoelectric coolers comprising a hot side, said hot sides each oriented to be facing said first side;
a control system that controls the activation of said first thermoelectric network; and
a control device connected to said control system operable to give information related to a preferred temperature setting;
receiving information from said control device; and
heating or cooling said cup based on said information from said control device.

16. The method of claim 15 wherein said control device comprises a switch.

17. The method of claim 15 wherein said control device comprises a temperature sensor.
